(19) United States
(12) Patent Application Publication
(10) Pub. No.: US 2024/0276251 A1
(43) Pub. Date: Aug. 15, 2024

(54) TRANSMITTING SCHEDULING REQUESTS DURING A BEAM FAILURE RECOVERY

(71) Applicant: QUALCOMM Incorporated, San Diego, CA (US)

(72) Inventors: Ruiming ZHENG, Beijing (CN); Linhai HE, San Diego, CA (US)

(21) Appl. No.: 18/566,874

(22) PCT Filed: Aug. 11, 2021
(86) PCT No.: PCT/CN2021/111965

§ 371 Date: Dec. 4, 2023

(51) Int. Cl. H04W 24/04; H04B 7/024

(52) U.S. Cl. CPC H04W 24/04; H04B 7/024

(57) ABSTRACT

Various aspects of the present disclosure generally relate to wireless communication. In some aspects, a user equipment (UE) may detect a beam failure at a first transmission-reception point (TRP) associated with a serving cell. The UE may transmit, to a base station via a second TRP, a scheduling request (SR) for a beam failure recovery (BFR) via a first SR physical uplink control channel (PUCCH) resource. The UE may detect a beam failure at a second TRP associated with the serving cell or another serving cell. The UE may transmit, to the base station, the SR via a second SR PUCCH resource with a spatial relation configured for the SR. Numerous other aspects are described.

### FIELD OF THE DISCLOSURE

Aspects of the present disclosure generally relate to wireless communication and to techniques and apparatuses for transmitting scheduling requests (SRs) during a beam failure recovery (BFR).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: detect a beam failure at a first transmission-reception point (TRP) associated with a serving cell: transmit, to a base station via a second TRP, a scheduling request (SR) for a beam failure recovery (BFR) via a first SR physical uplink control channel (PUCCH) resource: detect a beam failure at a second TRP associated with the serving cell or another serving cell; and transmit, to the base station, the SR via a second SR PUCCH resource with a spatial relation configured for the SR.

In some implementations, an apparatus for wireless communication at a base station includes a memory and one or more processors, coupled to the memory, configured to: receive, from a UE via a second TRP based at least in part on a beam failure at a first TRP associated with a serving cell, an SR for a BFR via a first SR PUCCH resource; and receive, from the UE based at least in part on a beam failure at the second TRP associated with the serving cell or another serving cell, the SR via a second SR PUCCH resource with a spatial relation configured for the SR.

In some implementations, a method of wireless communication performed by a UE includes detecting a beam failure at a first TRP associated with a serving cell: transmitting, to a base station via a second TRP, an SR for a BFR via a first SR PUCCH resource: detecting a beam failure at a second TRP associated with the serving cell or another serving cell; and transmitting, to the base station, the SR via a second SR PUCCH resource with a spatial relation configured for the SR.

In some implementations, a method of wireless communication performed by a base station includes receiving, from a UE via a second TRP based at least in part on a beam failure at a first TRP associated with a serving cell, an SR for a BFR via a first SR PUCCH resource; and receiving, from the UE based at least in part on a beam failure at the second TRP associated with the serving cell or another serving cell, the SR via a second SR PUCCH resource with a spatial relation configured for the SR.

In some implementations, a non-transitory computer-readable medium storing a set of instructions for wireless communication includes one or more instructions that, when executed by one or more processors of a UE, cause the UE to: detect a beam failure at a first TRP associated with a serving cell: transmit, to a base station via a second TRP, an SR for a BFR via a first SR PUCCH resource: detect a beam failure at a second TRP associated with the serving cell or another serving cell; and transmit, to the base station, the SR via a second SR PUCCH resource with a spatial relation configured for the SR.

In some implementations, a non-transitory computer-readable medium storing a set of instructions for wireless communication includes one or more instructions that, when executed by one or more processors of a base station, cause the base station to: receive, from a UE via a second TRP based at least in part on a beam failure at a first TRP associated with a serving cell, an SR for a BFR via a first SR PUCCH resource; and receive, from the UE based at least in part on a beam failure at the second TRP associated with the serving cell or another serving cell, the SR via a second SR PUCCH resource with a spatial relation configured for the SR.

In some implementations, an apparatus for wireless communication includes means for detecting a beam failure at a first TRP associated with a serving cell: means for transmitting, to a base station via a second TRP, an SR for a BFR via a first SR PUCCH resource: means for detecting a beam failure at a second TRP associated with the serving cell or another serving cell; and means for transmitting, to the base station, the SR via a second SR PUCCH resource with a spatial relation configured for the SR.

In some implementations, an apparatus for wireless communication includes means for receiving, from a UE via a second TRP based at least in part on a beam failure at a first TRP associated with a serving cell, an SR for a BFR via a first SR PUCCH resource; and means for receiving, from the UE based at least in part on a beam failure at the second TRP associated with the serving cell or another serving cell, the SR via a second SR PUCCH resource with a spatial relation configured for the SR.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a beam failure recovery (BFR) procedure, in accordance with the present disclosure.

FIG. 4 is a diagram illustrating an example of a multi-transmission reception point (multi-TRP) operation, in accordance with the present disclosure.

FIGS. 5-8 are diagrams illustrating examples associated with transmitting scheduling requests (SRs) during a BFR, in accordance with the present disclosure.

FIGS. 9-10 are diagrams illustrating example processes associated with transmitting SRs during a BFR, in accordance with the present disclosure.

FIGS. 11-12 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

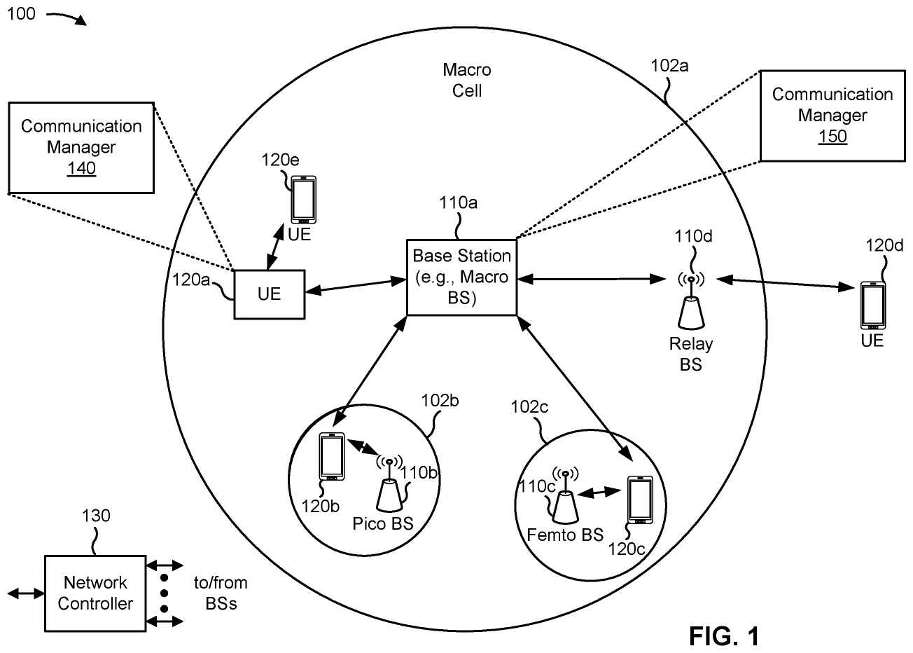

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS in 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrow band IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FRI (410 MHz-7.125 GHZ) and FR2 (24.25 GHz-52.6 GHz). It should be understood that although a portion of FR1 is greater than 6 GHZ, FRI is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHZ-71 GHz), FR4 (52.6 GHZ-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2. FR4. FR4-a or FR4-1, and/or FR5, or may be within the EHF band. It is contemplated that the frequencies included in these operating bands (e.g., FR1. FR2. FR3. FR4. FR4-a. FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may detect a beam failure at a first TRP associated with a serving cell: transmit, to a base station via a second TRP, a scheduling request (SR) for a beam failure recovery (BFR) via a first SR physical uplink control channel (PUCCH) resource: detect a beam failure at a second TRP associated with the serving cell or another serving cell; and transmit, to the base station, the SR via a second SR PUCCH resource with a spatial relation configured for the SR. Additionally, or alternatively, the communication manager 140 may perform one or more other operations described herein.

In some aspects, a base station (e.g., base station 110) may include a communication manager 150. As described in more detail elsewhere herein, the communication manager 150 may receive, from a UE via a second TRP based at least in part on a beam failure at a first TRP associated with a serving cell, an SR for a BFR via a first SR PUCCH resource; and receive, from the UE based at least in part on a beam failure at the second TRP associated with the serving cell or another serving cell, the SR via a second SR PUCCH resource with a spatial relation configured for the SR. Additionally. or alternatively, the communication manager 150 may perform one or more other operations described herein.

As indicated above. FIG. 1 is provided as an example. Other examples may differ from what is described with regard to FIG. 1.

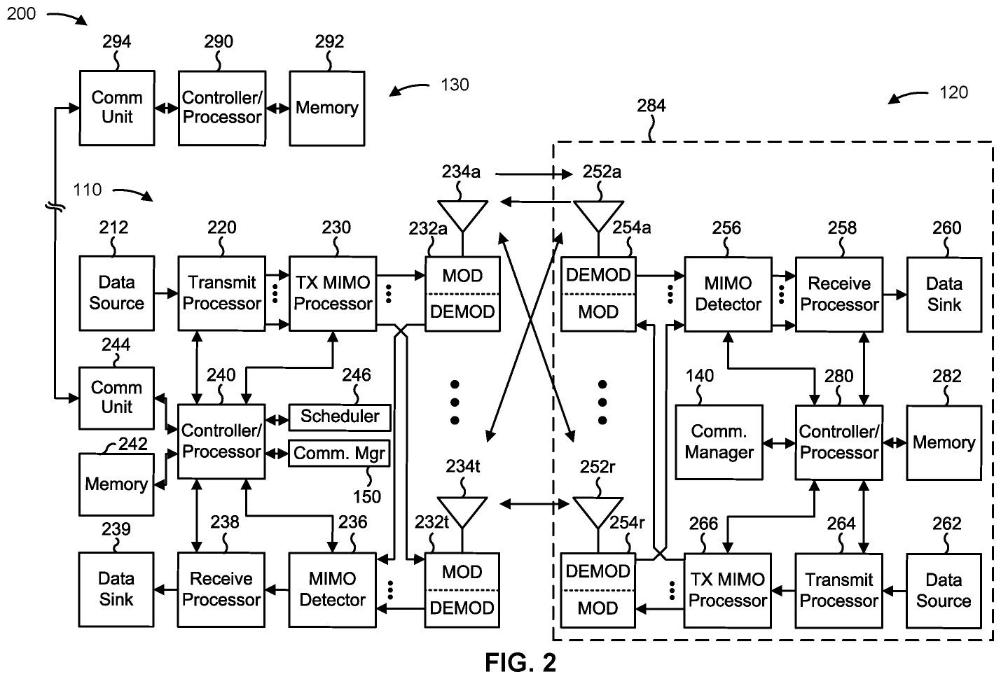

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g. T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

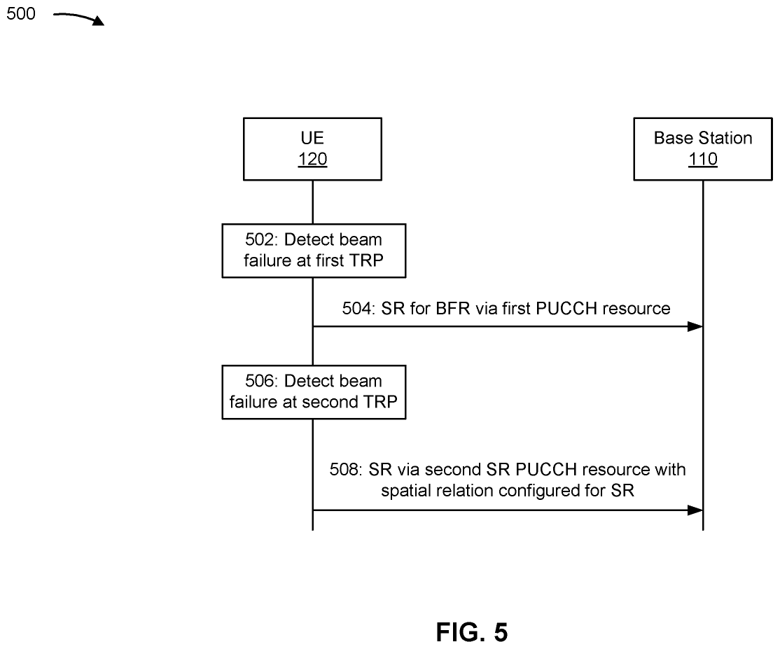

On the uplink, at the UE 120, a transmit processor 264 may receive and process data from a data source 262 and control information (e.g., for reports that include RSRP. RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-12).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-12).

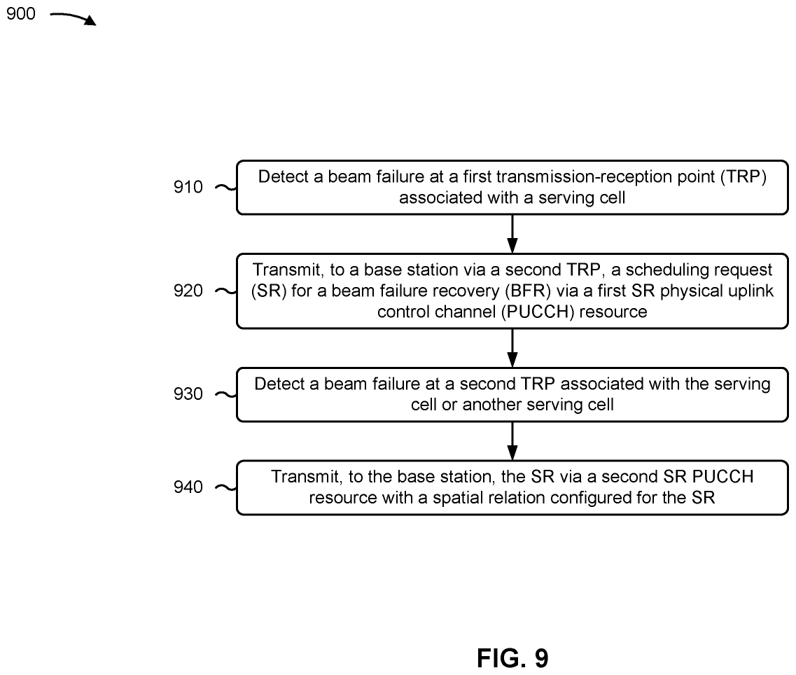

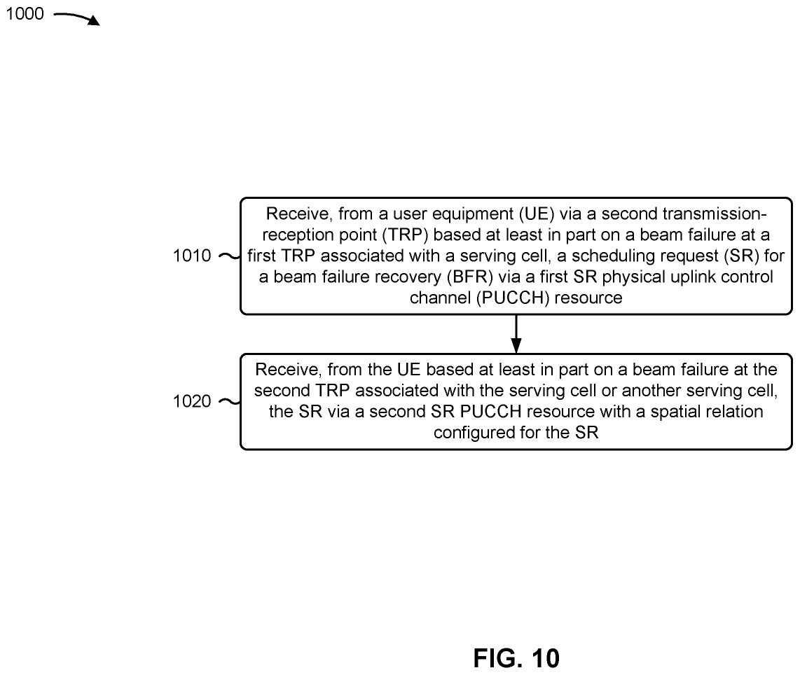

The controller/processor 240 of the base station 110, the controller/processor 280 of the UE 120, and/or any other component(s) of FIG. 2 may perform one or more techniques associated with transmitting SRs during a BFR, as described in more detail elsewhere herein. For example, the controller/processor 240 of the base station 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a UE (e.g., UE 120) includes means for detecting a beam failure at a first TRP associated with a serving cell: means for transmitting, to a base station via a second TRP, an SR for a BFR via a first SR PUCCH resource: means for detecting a beam failure at a second TRP associated with the serving cell or another serving cell; and/or means for transmitting, to the base station, the SR via a second SR PUCCH resource with a spatial relation configured for the SR. The means for the UE to perform operations described herein may include, for example, one or more of communication manager 140, antenna 252, modem 254. MIMO detector 256, receive processor 258, transmit processor 264, TX MIMO processor 266, controller/processor 280, or memory 282.

In some aspects, a base station (e.g., base station 110) includes means for receiving, from a UE via a second TRP based at least in part on a beam failure at a first TRP associated with a serving cell, an SR for a BFR via a first SR PUCCH resource; and/or means for receiving, from the UE based at least in part on a beam failure at the second TRP associated with the serving cell or another serving cell, the SR via a second SR PUCCH resource with a spatial relation configured for the SR. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

A medium access control (MAC) entity of a UE may be configured via radio resource control (RRC) signaling per serving cell with a BFR procedure. The UE may use the BFR procedure to indicate, to a serving base station, a new synchronization signal block (SSB) or channel state information reference signal (CSI-RS) when a beam failure is detected on serving SSB(s) and/or CSI-RS(s). The UE may detect the beam failure by counting beam failure instance (BFI) indications transmitted from lower layers of the UE to the MAC entity. The MAC entity may be configured for beam failure detection for each serving cell. When a BFI indication has been received from the lower layers, the MAC entity may start or restart a beam failure detection timer. The MAC entity may increment a BFI counter by one. When the BFI counter satisfies a beam failure instance maximum count, and when the serving cell is a secondary cell (SCell), the MAC entity may trigger a BFR for the serving cell. Otherwise, the MAC entity may initiate a random access procedure on a special cell (SpCell). For an SpCell BFR, the UE may initiate the random access channel (RACH) procedure for BFR. A BFR MAC control element (MAC-CE) may be carried in a RACH as a BFR indication.

When the BFR procedure determines that at least one BFR has been triggered and not canceled for an SCell for which an evaluation of candidate beams has been completed, and when uplink shared channel (SCH) resources are available for a new transmission and the uplink SCH resources may accommodate the BFR MAC-CE and a sub-header as a result of logical channel prioritization (LCP), the MAC entity may instruct a multiplexing and assembly procedure to generate the BFR MAC-CE. Otherwise, when the uplink shared channel resources are available for the new transmission and the uplink SCH resources may accommodate a truncated BFR MAC-CE and a sub-header as a result of LCP, the MAC entity may instruct the multiplexing and assembly procedure to generate the truncated BFR MAC-CE. Otherwise, the MAC entity may trigger an SR for an SCell BFR for each SCell for which BFR has been triggered, not canceled, and for which an evaluation of candidate beams has been completed.

A plurality of BFRs (e.g., all BFRs) triggered for an SCell may be canceled when a MAC protocol data unit (PDU) is transmitted, and the MAC PDU includes the BFR MAC-CE (or the truncated BFR MAC-CE), which may contain beam failure information of the SCell.

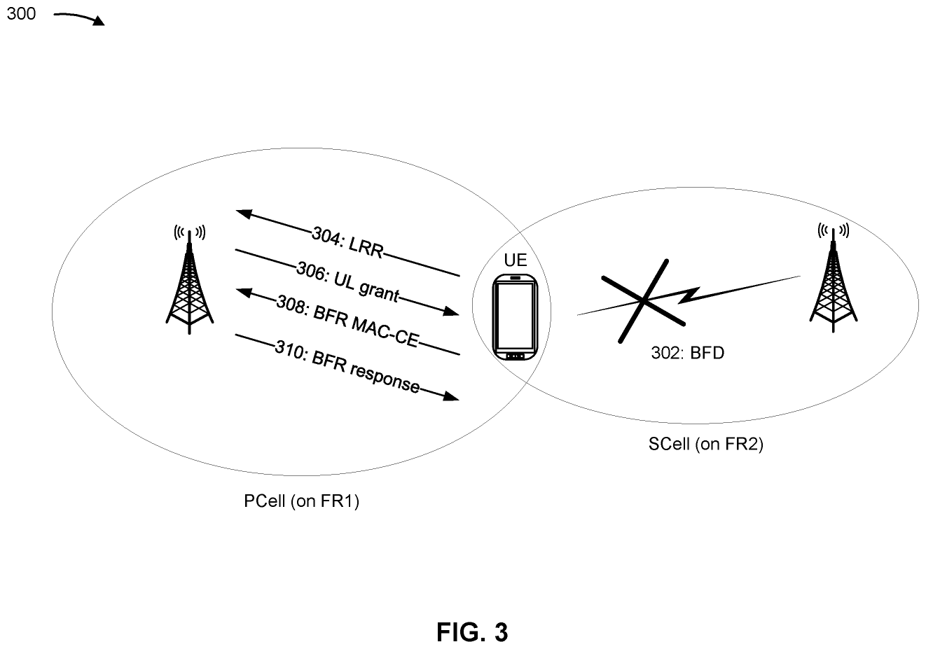

FIG. 3 is a diagram illustrating an example 300 of a BFR procedure, in accordance with the present disclosure.

In an SR based BFR for an SCell, a UE may be associated with a primary cell (PCell) on FRI and the SCell on FR2. As shown by reference number 302, the UE may detect that a plurality of downlink control beams have failed for the SCell on FR2. The UE may detect a failure of the plurality of downlink control beams during a beam failure detection. As shown by reference number 304, the UE may transmit, to the PCell, a link recovery request (LRR) (and/or an SR). The UE may transmit the LRR and/or the SR on the PCell on FRI via a dedicated PUCCH resource. As shown by reference number 306, the PCell may allocate an uplink grant for the UE to report a failed SCell index. As shown by reference number 308, the UE may transmit a BFR MAC-CE to report the failed SCell index and potential new candidate beams. As shown by reference number 310, the PCell may transmit a BFR response to the UE, which may acknowledge a reception of the BFR MAC-CE.

As indicated above. FIG. 3 is provided as an example. Other examples may differ from what is described with regard to FIG. 3.

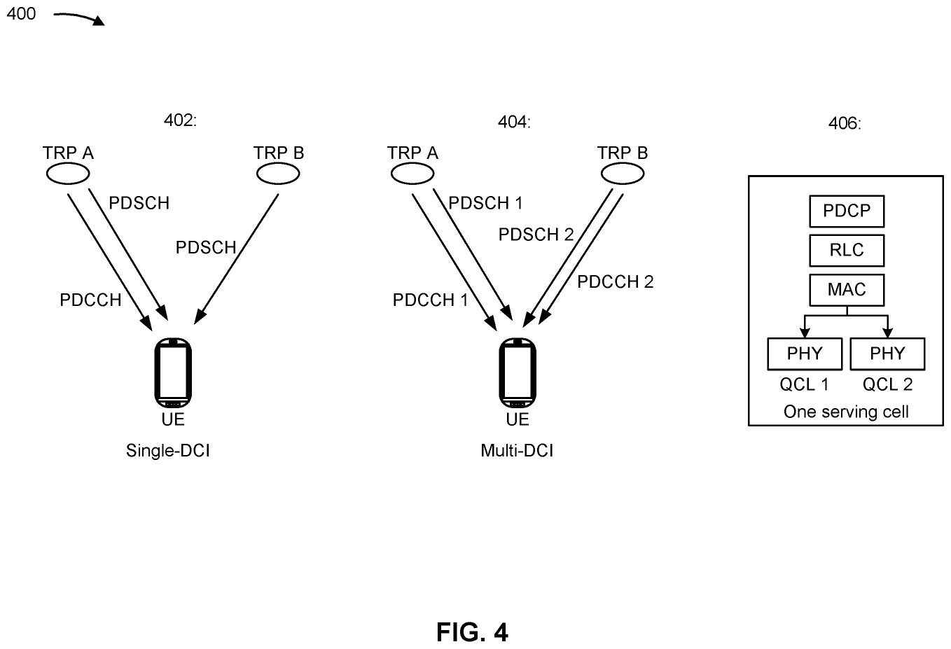

FIG. 4 is a diagram illustrating an example 400 of multi-TRP operation, in accordance with the present disclosure. The multi-TRP operation may be defined in a given serving cell from a UE perspective. The multi-TRP operation may be associated with a same physical cell identifier (PCI). The multi-TRP operation may be a single downlink control information (DCI) based multi-TRP operation or a multi-DCI based TRP operation.

As shown by reference number 402, in the single-DCI based TRP operation, a UE may receive a physical downlink control channel (PDCCH) and a first physical downlink shared channel (PDSCH) from a first TRP (TRP A). The UE may receive a second PDSCH from a second TRP (TRP B). The single-DCI based TRP operation may be applicable to an ideal backhaul. Different PDSCH schemes may be used for robustness, such as spatial division multiplexing (SDM), frequency division multiplexing (FDM), or time division multiplexing (TDM).

As shown by reference number 404, in the multi-DCI based TRP operation, a UE may receive a first PDCCH and a first PDSCH from a first TRP. The UE may receive a second PDCCH and a second PDSCH from a second TRP. The multi-DCI based TRP operation may be applicable to an ideal backhaul or a non-ideal backhaul. Further, a carrier aggregation framework may be leveraged to treat different TRPs as different virtual component carriers from a UE capability perspective. A first DCI transmitted from the first TRP may schedule the first PDSCH transmitted from the first TRP, and a second DCI transmitted from the second TRP may schedule the second PDSCH transmitted from the second TRP.

As shown by reference number 406, one serving cell may be associated with a first physical (PHY) layer and a second PHY layer. The first PHY layer may be associated with a first quasi co-location (QCL), and the second PHY layer may be associated with a second QCL. The first PHY layer and the second PHY layer may be connected to a MAC layer, a radio link control (RLC) layer, and a packet data convergence protocol (PDCP) layer, which may each be common between the first PHY layer and the second PHY layer.

As indicated above. FIG. 4 is provided as an example. Other examples may differ from what is described with regard to FIG. 4.

A BFR procedure may be employed in a multi-TRP operation. For an SCell BFR, when a beam failure is detected in one TRP (e.g., a first TRP) of one SCell, an SCell BFR procedure may be employed. A UE may transmit an SR via a PUCCH resource in a workable TRP to request an uplink grant, where the workable TRP may be a non-failed TRP with a workable PUCCH resource. When the beam failure is detected in the first TRP, the UE may transmit the SR via the PUCCH resource with a spatial relation towards a second TRP for BFR. A multi-TRP BFR MAC-CE (or truncated multi-TRP BFR MAC-CE) may include a failed TRP index. An indication of a UE-preferred new beam (when detected) may be transmitted via a granted uplink resource. For an SpCell BFR, when a beam failure is detected in one TRP (e.g., a first TRP) and BFR is triggered, the BFR procedure may be performed via another TRP (e.g., a second TRP) rather than using a RACH.

One SR configuration corresponding to an SCell BFR may be configured per master cell group (MCG) via RRC signaling. Alternatively, an SR configuration may support up to two spatial relations for a corresponding PUCCH resource for an SR, based at least in part on a scheduling request resource configuration (SchedulingRequestResourceConfig) information element (IE). Each spatial relation may be associated with spatial relation information. Thus, an SR resource may be configured with two PUCCH resources with spatial relations. For example, two PUCCH resource identifiers may be configured, with one spatial relation information for each PUCCH resource identifier. As another example, one PUCCH resource identifier may be configured with two spatial relation information.

For a beam failure recovery request (BFRQ) of a multi-TRP BFR, up to two dedicated PUCCH SR resources may be in a cell group. A PUCCH SR for an SCell may be reused for a multi-TRP operation. A BFRQ MAC-CE may convey information of failed component carrier (CC) indices, a new candidate beam for a failed TRP/CC (when found), and/or an indication of whether the new candidate beam is found. The BFRQ MAC-CE may support an indication of a single TRP failure. The BFRQ MAC-CE may support an indication of more than one TRP failure, a corresponding BFR procedure, and/or an applicable cell type (e.g., SCell or SpCell). A UE behavior may be defined when a TRP failure status is different across cells. A PUCCH-SR resource may be configured with two spatial relations.

A UE configured with a TRP-specific BFR may be configured with one PUCCH-SR resource in a cell group. Alternatively, the UE may be configured with up to two PUCCH-SR resources in the cell group.

An SR for a multi-TRP BFR procedure should be enhanced based at least in part on up to two PUCCH resources/spatial relations being able to be configured for the SR in the multi-TRP operation. The UE may transmit the SR via a workable TRP due to a beam failure detected in the first TRP. The workable TRP may be the non-failed TRP with a workable spatial relation, such as a spatial relation toward the second TRP. Before the UE receives any uplink grants and transmits the multi-TRP BFR MAC-CE, beam failure may be detected in the second TRP (or another TRP) of a same SCell and/or beam failure may be detected in the second TRP (or another TRP) of other SCells. A BFR procedure for the second TRP (or another TRP) and an SR procedure with two PUCCH resources/spatial relations should be enhanced.

Previous designs have considered one SR configuration corresponding to an SCell BFR being configured per MCG via RRC signaling. However, the previous designs have not considered the SR for the multi-TRP BFR procedure based at least in part on up to two PUCCH resources/spatial relations being able to be configured for the SR in the multi-TRP operation. The previous designs have not considered the BFR procedure for the second TRP (or another TRP) and the SR procedure with the two PUCCH resources/spatial relations.

In various aspects of techniques and apparatuses described herein, a UE may detect a beam failure at a first TRP associated with a serving cell. The serving cell may be an SCell. The UE may transmit, to a base station via a second TRP, an SR for a BFR via a first SR PUCCH resource. The UE may detect a beam failure at a second TRP associated with the serving cell or another serving cell. The UE may transmit, to the base station, the SR via a second SR PUCCH resource with a spatial relation configured for the SR. The first SR PUCCH resource and the second SR PUCCH resource with the spatial relation configured for the SR may be different SR PUCCH resources of the SR. Alternatively, the first SR PUCCH resource and the second SR PUCCH resource with the spatial relation configured for the SR may be same SR PUCCH resources of the SR but with different spatial relations. As a result, the UE may perform a BFR procedure based at least in part on an SR resource configuration associated with two PUCCH resources/spatial relations in a multi-TRP operation.

FIG. 5 is a diagram illustrating an example 500 associated with transmitting SRs during a BFR, in accordance with the present disclosure. As shown in FIG. 5, example 500 includes communication between a UE (e.g., UE 120) and a base station (e.g., base station 110). In some aspects, the UE and the base station may be included in a wireless network, such as wireless network 100.

As shown by reference number 502, the UE may detect a beam failure at a first TRP associated with a serving cell. The serving cell may be an SCell or an SpCell.

As shown by reference number 504, the UE may transmit, to the base station via a second TRP, an SR for a BFR via a first SR PUCCH resource. The SR may be associated with an SR resource, where the SR resource may be configured via an SR resource configuration with PUCCH resources with up to two spatial relations. The PUCCH resources may include two PUCCH resources each configured with one spatial relation or one PUCCH resource configured with two spatial relations.

As shown by reference number 506, the UE may detect a beam failure at a second TRP associated with the serving cell or another serving cell. The UE may detect the beam failure at the second TRP after transmitting the SR based at least in part on the beam failure at the first TRP.

As shown by reference number 508, the UE may transmit, to the base station, the SR via a second SR PUCCH resource with a spatial relation configured for the SR. The UE may transmit the SR via the second SR PUCCH resource with the spatial relation configured for the SR based at least in part on no uplink grant being available for the UE. In some aspects, the first SR PUCCH resource and the second SR PUCCH resource with the spatial relation configured for the SR may be different SR PUCCH resources of the SR. Alternatively, the first SR PUCCH resource and the second SR PUCCH resource with the spatial relation configured for the SR may be same SR PUCCH resources of the SR but with different spatial relations.

In some aspects, the UE may receive, from the base station, an uplink grant. The UE may transmit, to the base station via the uplink grant, a multi-TRP BFR MAC-CE or a truncated multi-TRP BFR MAC-CE that indicates a failed TRP index and a UE-preferred new beam.

In some aspects, the UE may receive, from the base station, an SR resource configuration for a serving cell BFR in a multi-TRP operation, where the SR resource configuration may indicate an SR prohibit timer and an SR counter. In some aspects, the UE may stop the SR prohibit timer associated with each TRP based at least in part on a transmitted multi-TRP BFR MAC-CE or a transmitted truncated multi-TRP BFR MAC-CE indicating a failed TRP index.

In some aspects, the SR prohibit timer may be configured per TRP in one SR resource configuration. The UE may not be prohibited from transmitting an SR via another PUCCH resource spatial relation. The SR prohibit timer may maintain an SR transmission prohibition within one TRP.

In some aspects, the SR prohibit timer may be configured per SR resource configuration. The SR prohibit timer may be shared across the first TRP and the second TRP. The UE may be prohibited from transmitting an SR via another PUCCH resource spatial relation when the SR prohibit timer is running. The SR prohibit timer may be started or restarted based at least in part on an SR being transmitted via any PUCCH resource spatial relation.

In some aspects, the SR counter may be configured per TRP in one SR resource configuration. The UE may be associated with separate SR counters for each TRP with different SR PUCCH resource spatial relations. In some aspects, the SR counter may be configured per SR resource configuration. The SR counter may be incremented based at least in part on an SR being transmitted via any PUCCH resource spatial relation.

In some aspects, the UE may start a timer after transmitting, for the second TRP, the SR via the first SR PUCCH resource. The UE may determine that the timer has expired after detecting the beam failure at the second TRP associated with the serving cell or another serving cell. The UE may transmit the SR via the second SR PUCCH resource with the spatial relation configured for the SR based at least in part on the timer having expired. The UE may restart the timer after transmitting the SR via the second SR PUCCH resource with the spatial relation configured for the SR.

In some aspects, the UE may start a timer after transmitting, for the second TRP, the SR via the first SR PUCCH resource. The UE may receive, from the base station, an uplink grant prior to an expiry of the timer. The UE may transmit, to the base station via the uplink grant, a multi-TRP BFR MAC-CE or a truncated multi-TRP BFR MAC-CE that indicates a failed TRP index and a UE-preferred new beam.

In some aspects, the UE may perform an RACH procedure for BFR based at least in part on the beam failure at the first TRP and the beam failure at the second TRP. The UE may transmit, to the base station via an uplink grant and based at least in part on the RACH procedure, a multi-TRP BFR MAC-CE or a truncated multi-TRP BFR MAC-CE.

As indicated above. FIG. 5 is provided as an example. Other examples may differ from what is described with regard to FIG. 5.

In some aspects, a UE (e.g., UE 120) may detect a beam failure in a first TRP, and an SR may be triggered via a PUCCH resource of a workable TRP, such as a second TRP. The workable TRP may be one SR PUCCH resource with a workable spatial relation. When the UE further detects the beam failure in the second TRP in the same and/or other SCells while no uplink grant is available, the UE may transmit the SR via a PUCCH resource with a spatial relation configured within the same SR. The PUCCH resource with the spatial relation configured for the same SR may be a second PUCCH resource of the SR, or a same PUCCH resource of the SR but with another spatial relation (when configured).

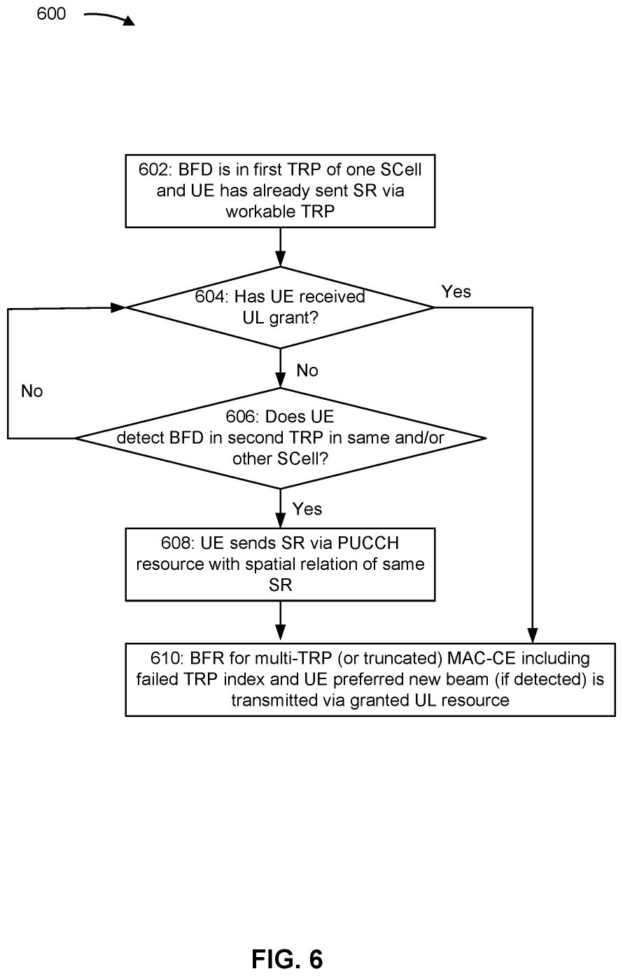

FIG. 6 is a diagram illustrating an example 600 associated with transmitting SRs during a BFR, in accordance with the present disclosure.

As shown by reference number 602, a UE may detect a beam failure in a first TRP of one SCell and the UE may transmit an SR via a workable TRP. As shown by reference number 604, the UE may determine whether an uplink grant has been received. When the uplink grant has not been received, as shown by reference number 606, the UE may determine whether a beam failure is detected in a second TRP in the same and/or other SCells. When no beam failure is detected in the second TRP in the same and/or other SCells, the UE may again determine whether the uplink grant has been received. When the beam failure is detected in the second TRP in the same and/or other SCells, as shown by reference number 608, the UE may transmit the SR via a PUCCH resource with a spatial relation configured within the same SR. As shown by reference number 610, after the UE transmits the SR via the PUCCH resource with the spatial relation configured within the same SR and after the uplink grant is received, the UE may transmit a BFR for a multi-TRP MAC-CE (or a truncated multi-TRP MAC-CE) including a failed TRP index and a UE-preferred new beam (when detected) via a granted uplink resource.

In some aspects, after the UE detects the beam failure in the first TRP of one SCell and the UE transmits the SR via the workable TRP, and based at least in part on the UE receiving the uplink grant, the UE may transmit the BFR for the multi-TRP MAC-CE (or the truncated multi-TRP MAC-CE) including the failed TRP index and the UE-preferred new beam (when detected) via the granted uplink resource

As indicated above. FIG. 6 is provided as an example. Other examples may differ from what is described with regard to FIG. 6.

In some aspects, an SR resource configuration for SCell BFR in a multi-TRP operation may include various parameters. An SR prohibit timer (sr-ProhibitTimer) may be configured per TRP in one SR configuration, or per SR configuration. When the SR prohibit timer is configured per TRP in one SR configuration, a UE may not be prohibited from transmitting an SR via another PUCCH resource spatial relation, and the SR prohibit timer may only maintain an SR transmission prohibition within one TRP. When the SR prohibit timer is configured per SR configuration, the SR prohibit timer may be shared across two TRPs, and the SR for another PUCCH resource spatial relation may be prohibited when the SR prohibit timer is running. The SR prohibit timer may start (or restart) when the SR is transmitted via any PUCCH resource spatial relation.

In some aspects, when the SR is triggered by a BFR of an SCell and a transmitted MAC PDU includes a multi-TRP BFR MAC-CE (or truncated multi-TRP BFR MAC-CE) containing beam failure recovery information for the SCell, the SR that is pending may be canceled. Further, when the SR prohibit timer is configured per TRP in one SR configuration, corresponding SR prohibit timer(s) associated with each TRP may be stopped when the multi-TRP BFR MAC-CE (or truncated multi-TRP BFR MAC-CE) contains failed TRP information. When the SR prohibit timer is configured per SR configuration, the SR prohibit timer(s) may be stopped.

In some aspects, an SR counter may be configured per TRP in one SR configuration, or per SR configuration. When the SR counter is configured per TRP in one SR configuration, the UE may maintain a separate SR counter for each TRP with different SR PUCCH resource spatial relations. When the SR counter is per SR configuration, the SR counter may be incremented by one for the SR being transmitted via any PUCCH resource spatial relation.

In some aspects, for a per TRP SR resource configuration, a timer may be employed to avoid transmitting excessive SRs from any PUCCH resource with a spatial relation. A UE may not transmit an SR via another PUCCH resource with a spatial relation when the timer is running. When the timer expires, the UE may be permitted to transmit the SR from another PUCCH resource with the spatial relation. For example, when the UE has transmitted an SR for BFR for a first TRP and an uplink grant has not yet been received, the UE may not transmit another SR for BFR for a second TRP until the timer expires.

In some aspects, the SR may be triggered via the PUCCH resource of a workable TRP due to a beam failure detection in the first TRP, and a timer may be started. The UE may not yet have received any uplink grant, and meanwhile, the UE may detect beam failure in the second TRP (or another TRP) of a same SCell and/or other SCells. When the UE receives the uplink grant before an expiry of the timer, the UE may report a multi-TRP BFR MAC-CE (or truncated multi-TRP BFR MAC-CE) via a granted uplink resource. When the timer expires and still no uplink grant has been received, the UE may transmit the SR via another PUCCH resource with a spatial relation configured in the same SR. The UE may obey an SR prohibit timer for the second TRP. The timer may restart after the UE transmits the SR via the other PUCCH resource with the spatial relation.

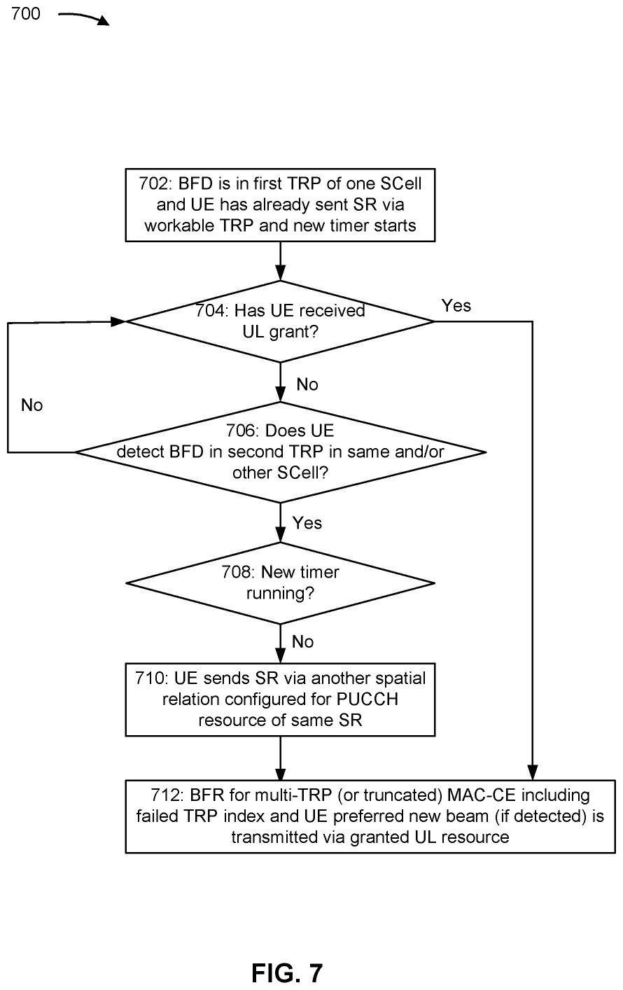

FIG. 7 is a diagram illustrating an example 700 associated with transmitting SRs during a BFR, in accordance with the present disclosure.

As shown by reference number 702, a UE may detect a beam failure in a first TRP of one SCell. The UE may transmit an SR via a workable TRP, and a timer may start. As shown by reference number 704, the UE may determine whether an uplink grant has been received. When the uplink grant has not been received, as shown by reference number 706, the UE may determine whether a beam failure is detected in the second TRP in the same and/or other SCells. When no beam failure is detected in the second TRP in the same and/or other SCells, the UE may again determine whether the uplink grant has been received. When the beam failure is detected in the second TRP in the same and/or other SCells, as shown by reference number 708, the UE may determine whether the timer is running. When the timer is not running, as shown by reference number 710, the UE may transmit the SR via another spatial relation configured for a PUCCH resource of the same SR. As shown by reference number 712, after the UE transmits the SR via the other spatial relation configured for the PUCCH resource of the same SR and after the uplink grant is received, the UE may transmit a BFR for a multi-TRP MAC-CE (or a truncated multi-TRP MAC-CE) including a failed TRP index and a UE-preferred new beam (when detected) via a granted uplink resource.

In some aspects, after the UE detects the beam failure in the first TRP of one SCell and the UE transmits the SR via the workable TRP, and based at least in part on the UE receiving the uplink grant, the UE may transmit the BFR for the multi-TRP MAC-CE (or the truncated multi-TRP MAC-CE) including the failed TRP index and the UE-preferred new beam (when detected) via the granted uplink resource

As indicated above. FIG. 7 is provided as an example. Other examples may differ from what is described with regard to FIG. 7.

In some aspects, a UE may not transmit an SR via another PUCCH resource with a spatial relation of a same SR before the UE receives an uplink grant. In other words, the UE may not transmit another SR before receiving the uplink grant.

In some aspects, a UE may detect a beam failure in a first TRP of an SpCell. and the UE may transmit an SR via a PUCCH resource of a workable TRP (e.g., a second TRP) in the SpCell. When a beam failure is further detected in the second TRP (or another TRP) of the same SpCell and no uplink grant is available, the UE may consider that both TRPs are failed in the SpCell. The UE may perform a RACH for BFR instead of using an SR for BFR, due to no workable TRP when both TRPs have failed. A multi-TRP BFR MAC-CE (or truncated multi-TRP BFR MAC-CE) may be transmitted via the RACH.

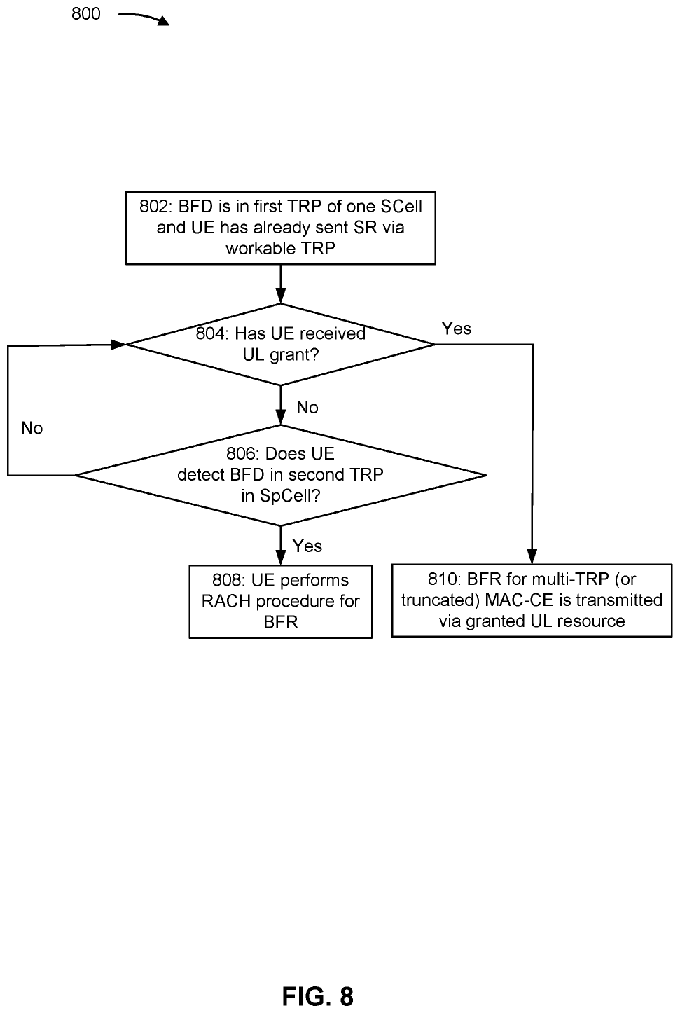

FIG. 8 is a diagram illustrating an example 800 associated with transmitting SRs during a BFR, in accordance with the present disclosure.

As shown by reference number 802, a UE may detect a beam failure in a first TRP of an SpCell and the UE may transmit an SR via a workable TRP. As shown by reference number 804, the UE may determine whether an uplink grant has been received. When the uplink grant has not been received, as shown by reference number 806, the UE may determine whether a beam failure is detected in a second TRP in the SpCell. When no beam failure is detected in the second TRP in the SpCell, the UE may again determine whether the uplink grant has been received. When the beam failure is detected in the second TRP in the SpCell, as shown by reference number 808, the UE may perform a RACH procedure for BFR. When the uplink grant has been received, as shown by reference number 810, the UE may transmit a BFR for a multi-TRP MAC-CE (or a truncated multi-TRP MAC-CE) via a granted uplink resource.

As indicated above, FIG. 8 is provided as an example. Other examples may differ from what is described with regard to FIG. 8.

FIG. 9 is a diagram illustrating an example process 900 performed, for example, by a UE, in accordance with the present disclosure. Example process 900 is an example where the UE (e.g., UE 120) performs operations associated with transmitting SRs during a BFR.

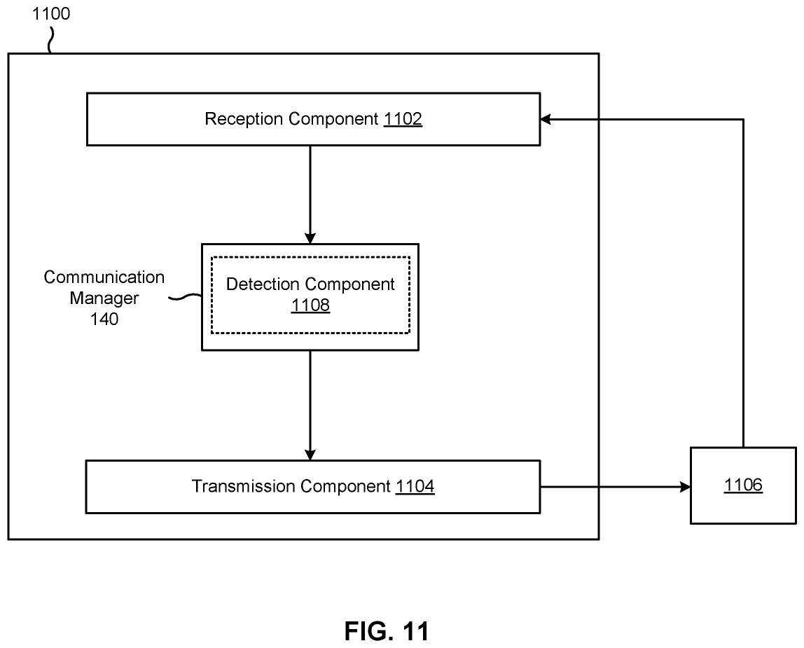

As shown in FIG. 9, in some aspects, process 900 may include detecting a beam failure at a first TRP associated with a serving cell (block 910). For example, the UE (e.g., using communication manager 140 and/or detection component 1108, depicted in FIG. 11) may detect a beam failure at a first TRP associated with a serving cell, as described above.

As further shown in FIG. 9, in some aspects, process 900 may include transmitting, to a base station via a second TRP, an SR for a BFR via a first SR PUCCH resource (block 920). For example, the UE (e.g., using communication manager 140 and/or transmission component 1104, depicted in FIG. 11) may transmit, to a base station via a second TRP, an SR for a BFR via a first SR PUCCH resource, as described above.

As further shown in FIG. 9, in some aspects, process 900 may include detecting a beam failure at a second TRP associated with the serving cell or another serving cell (block 930). For example, the UE (e.g., using communication manager 140 and/or detection component 1108, depicted in FIG. 11) may detect a beam failure at a second TRP associated with the serving cell or another serving cell, as described above.

As further shown in FIG. 9, in some aspects, process 900 may include transmitting, to the base station, the SR via a second SR PUCCH resource with a spatial relation configured for the SR (block 940). For example, the UE (e.g., using communication manager 140 and/or transmission component 1104, depicted in FIG. 11) may transmit, to the base station, the SR via a second SR PUCCH resource with a spatial relation configured for the SR, as described above.

Process 900 may include additional aspects, such as any single aspect or any combination of aspects described below and/or in connection with one or more other processes described elsewhere herein.

In a first aspect, the first SR PUCCH resource and the second SR PUCCH resource with the spatial relation configured for the SR are different SR PUCCH resources of the SR, or the first SR PUCCH resource and the second SR PUCCH resource with the spatial relation configured for the SR are same SR PUCCH resources of the SR but with different spatial relations.

In a second aspect, alone or in combination with the first aspect, transmitting the SR via the second SR PUCCH resource with the spatial relation configured for the SR is based at least in part on no uplink grant being available for the UE.

In a third aspect, alone or in combination with one or more of the first and second aspects, process 900 includes receiving, from the base station, an uplink grant, and transmitting, to the base station via the uplink grant, a multi-TRP BFR MAC-CE or a truncated multi-TRP BFR MAC-CE that indicates a failed TRP index and a UE-preferred new beam.

In a fourth aspect, alone or in combination with one or more of the first through third aspects, process 900 includes receiving, from the base station, an SR resource configuration for a serving cell BFR in a multi-TRP operation, wherein the SR resource configuration at least indicates an SR prohibit timer and an SR counter.

In a fifth aspect, alone or in combination with one or more of the first through fourth aspects, the SR prohibit timer is configured per TRP in one SR resource configuration, wherein the UE is not prohibited from transmitting an SR via another PUCCH resource spatial relation, and the SR prohibit timer maintains an SR transmission prohibition within one TRP.

In a sixth aspect, alone or in combination with one or more of the first through fifth aspects, the SR prohibit timer is configured per SR resource configuration, wherein the SR prohibit timer is shared across the first TRP and the second TRP, wherein the UE is prohibited from transmitting an SR via another PUCCH resource spatial relation when the SR prohibit timer is running, and the SR prohibit timer is started or restarted based at least in part on an SR being transmitted via any PUCCH resource spatial relation.

In a seventh aspect, alone or in combination with one or more of the first through sixth aspects, process 900 includes stopping the SR prohibit timer associated with each TRP based at least in part on a transmitted multi-TRP BFR MAC-CE or a transmitted truncated multi-TRP BFR MAC-CE indicating a failed TRP index.

In an eighth aspect, alone or in combination with one or more of the first through seventh aspects, the SR counter is configured per TRP in one SR resource configuration, and the UE is associated with separate SR counters for each TRP with different SR PUCCH resource spatial relations: or the SR counter is configured per SR resource configuration, and the SR counter is incremented based at least in part on an SR being transmitted via any PUCCH resource spatial relation.

In a ninth aspect, alone or in combination with one or more of the first through eighth aspects, process 900 includes starting a timer after transmitting, for the second TRP, the SR via the first SR PUCCH resource, determining that the timer has expired after detecting the beam failure at the second TRP associated with the serving cell or another serving cell, wherein the SR is transmitted via the second SR PUCCH resource with the spatial relation configured for the SR based at least in part on the timer having expired, and restarting the timer after transmitting the SR via the second SR PUCCH resource with the spatial relation configured for the SR.

In a tenth aspect, alone or in combination with one or more of the first through ninth aspects, process 900 includes starting a timer after transmitting, for the second TRP, the SR via the first SR PUCCH resource, receiving, from the base station, an uplink grant prior to an expiry of the timer, and transmitting, to the base station via the uplink grant, a multi-TRP BFR MAC-CE or a truncated multi-TRP BFR MAC-CE that indicates a failed TRP index and a UE-preferred new beam.

In an eleventh aspect, alone or in combination with one or more of the first through tenth aspects, process 900 includes performing a RACH procedure for BFR based at least in part on the beam failure at the first TRP and the beam failure at the second TRP, and transmitting, to the base station via an uplink grant and based at least in part on the RACH procedure, a multi-TRP BFR MAC-CE or a truncated multi-TRP BFR MAC-CE.

In a twelfth aspect, alone or in combination with one or more of the first through eleventh aspects, the serving cell is an SCell or an SpCell.

In a thirteenth aspect, alone or in combination with one or more of the first through twelfth aspects, the SR is associated with an SR resource, wherein the SR resource is configured via an SR resource configuration with PUCCH resources with up to two spatial relations, and the PUCCH resources include two PUCCH resources each configured with one spatial relation or one PUCCH resource configured with two spatial relations.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a base station, in accordance with the present disclosure. Example process 1000 is an example where the base station (e.g., base station 110) performs operations associated with transmitting SRs during a BFR.

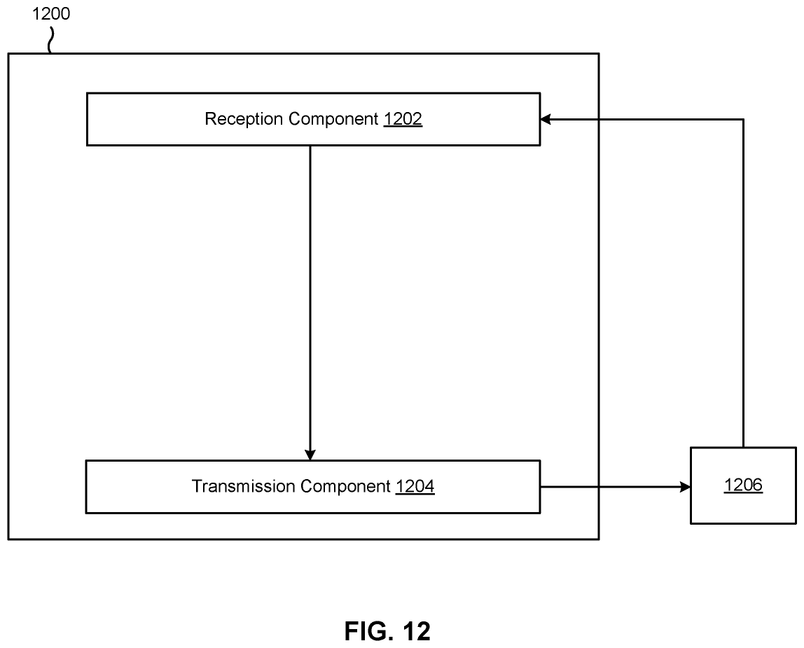

As shown in FIG. 10, in some aspects, process 1000 may include receiving, from a UE via a second TRP based at least in part on a beam failure at a first TRP associated with a serving cell, an SR for a BFR via a first SR PUCCH resource (block 1010). For example, the base station (e.g., using reception component 1202, depicted in FIG. 12) may receive, from a UE via a second TRP based at least in part on a beam failure at a first TRP associated with a serving cell, an SR for a BFR via a first SR PUCCH resource, as described above.

As further shown in FIG. 10, in some aspects, process 1000 may include receiving, from the UE based at least in part on a beam failure at the second TRP associated with the serving cell or another serving cell, the SR via a second SR PUCCH resource with a spatial relation configured for the SR (block 1020). For example, the base station (e.g., using reception component 1202, depicted in FIG. 12) may receive, from the UE based at least in part on a beam failure at the second TRP associated with the serving cell or another serving cell, the SR via a second SR PUCCH resource with a spatial relation configured for the SR, as described above.

Process 1000 may include additional aspects, such as any single aspect or any combination of aspects described below and/or in connection with one or more other processes described elsewhere herein.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include a detection component 1108, among other examples.

In some aspects, the apparatus 1100 may be configured to perform one or more operations described herein in connection with FIGS. 5-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally. or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The detection component 1108 may detect a beam failure at a first TRP associated with a serving cell. The transmission component 1104 may transmit, to a base station via a second TRP, an SR for a BFR via a first SR PUCCH resource. The detection component 1108 may detect a beam failure at a second TRP associated with the serving cell or another serving cell. The transmission component 1104 may transmit, to the base station, the SR via a second SR PUCCH resource with a spatial relation configured for the SR.

The reception component 1102 may receive, from the base station, an uplink grant. The transmission component 1104 may transmit, to the base station via the uplink grant, a multi-TRP BFR MAC-CE or a truncated multi-TRP BFR MAC-CE that indicates a failed TRP index and a UE-preferred new beam. The reception component 1102 may receive, from the base station, an SR resource configuration for a serving cell BFR in a multi-TRP operation, wherein the SR resource configuration at least indicates an SR prohibit timer and an SR counter.

The reception component 1102 may receive, from the base station, an uplink grant prior to an expiry of a timer. The transmission component 1104 may transmit, to the base station via the uplink grant, a multi-TRP BFR MAC-CE or a truncated multi-TRP BFR MAC-CE that indicates a failed TRP index and a UE-preferred new beam.

The reception component 1102 may receive, from a UE via a second TRP based at least in part on a beam failure at a first TRP associated with a serving cell, an SR for a BFR via a first SR PUCCH resource. The reception component 1102 may receive, from the UE based at least in part on a beam failure at the second TRP associated with the serving cell or another serving cell, the SR via a second SR PUCCH resource with a spatial relation configured for the SR.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a base station, or a base station may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204.

In some aspects, the apparatus 1200 may be configured to perform one or more operations described herein in connection with FIGS. 5-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the base station described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1206. In some aspects, the reception component 1202 may include one or more antennas, a modem, a demodulator, a MIMO detector, a receive processor, a controller/processor, a memory, or a combination thereof, of the base station described in connection with FIG. 2.

The transmission component 1204 may transmit communications, such as reference signals, control information, data communications, or a combination thereof, to the apparatus 1206. In some aspects, one or more other components of the apparatus 1206 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the base station described in connection with FIG. 2. In some aspects, the transmission component 1204 may be co-located with the reception component 1202 in a transceiver.

The reception component 1202 may receive, from a UE via a second TRP based at least in part on a beam failure at a first TRP associated with a serving cell, an SR for a BFR via a first SR PUCCH resource. The reception component 1202 may receive, from the UE based at least in part on a beam failure at the second TRP associated with the serving cell or another serving cell, the SR via a second SR PUCCH resource with a spatial relation configured for the SR.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: detecting a beam failure at a first transmission-reception point (TRP) associated with a serving cell: transmitting, to a base station via a second TRP, a scheduling request (SR) for a beam failure recovery (BFR) via a first SR physical uplink control channel (PUCCH) resource: detecting a beam failure at a second TRP associated with the serving cell or another serving cell; and transmitting, to the base station, the SR via a second SR PUCCH resource with a spatial relation configured for the SR.

Aspect 2: The method of Aspect 1, wherein: the first SR PUCCH resource and the second SR PUCCH resource with the spatial relation configured for the SR are different SR PUCCH resources of the SR: or the first SR PUCCH resource and the second SR PUCCH resource with the spatial relation configured for the SR are same SR PUCCH resources of the SR but with different spatial relations.

Aspect 3: The method of any of Aspects 1 through 2, wherein transmitting the SR via the second SR PUCCH resource with the spatial relation configured for the SR is based at least in part on no uplink grant being available for the UE.

Aspect 4: The method of any of Aspects 1 through 3, further comprising: receiving, from the base station, an uplink grant; and transmitting, to the base station via the uplink grant, a multi-TRP BFR medium access control control element (MAC-CE) or a truncated multi-TRP BFR MAC-CE that indicates a failed TRP index and a UE-preferred new beam.

Aspect 5: The method of any of Aspects 1 through 4, further comprising: receiving, from the base station, an SR resource configuration for a serving cell BFR in a multi-TRP operation, wherein the SR resource configuration at least indicates an SR prohibit timer and an SR counter.

Aspect 6: The method of Aspect 5, wherein the SR prohibit timer is configured per TRP in one SR resource configuration, wherein the UE is not prohibited from transmitting an SR via another PUCCH resource spatial relation, and wherein the SR prohibit timer maintains an SR transmission prohibition within one TRP.

Aspect 7: The method of Aspect 5, wherein the SR prohibit timer is configured per SR resource configuration, wherein the SR prohibit timer is shared across the first TRP and the second TRP, wherein the UE is prohibited from transmitting an SR via another PUCCH resource spatial relation when the SR prohibit timer is running, and wherein the SR prohibit timer is started or restarted based at least in part on an SR being transmitted via any PUCCH resource spatial relation.

Aspect 8: The method of Aspect 5, further comprising: stopping the SR prohibit timer associated with each TRP based at least in part on a transmitted multi-TRP BFR medium access control control element (MAC-CE) or a transmitted truncated multi-TRP BFR MAC-CE indicating a failed TRP index.

Aspect 9: The method of Aspect 5, wherein: the SR counter is configured per TRP in one SR resource configuration, and wherein the UE is associated with separate SR counters for each TRP with different SR PUCCH resource spatial relations: or the SR counter is configured per SR resource configuration, and wherein the SR counter is incremented based at least in part on an SR being transmitted via any PUCCH resource spatial relation.

Aspect 10: The method of any of Aspects 1 through 9, further comprising: starting a timer after transmitting, for the second TRP, the SR via the first SR PUCCH resource; determining that the timer has expired after detecting the beam failure at the second TRP associated with the serving cell or another serving cell, wherein the SR is transmitted via the second SR PUCCH resource with the spatial relation configured for the SR based at least in part on the timer having expired; and restarting the timer after transmitting the SR via the second SR PUCCH resource with the spatial relation configured for the SR.

Aspect 11: The method of any of Aspects 1 through 10, further comprising: starting a timer after transmitting, for the second TRP, the SR via the first SR PUCCH resource; receiving, from the base station, an uplink grant prior to an expiry of the timer; and transmitting, to the base station via the uplink grant, a multi-TRP BFR medium access control control element (MAC-CE) or a truncated multi-TRP BFR MAC-CE that indicates a failed TRP index and a UE-preferred new beam.

Aspect 12: The method of any of Aspects 1 through 11, further comprising: performing a random access channel (RACH) procedure for BFR based at least in part on the beam failure at the first TRP and the beam failure at the second TRP; and transmitting, to the base station via an uplink grant and based at least in part on the RACH procedure, a multi-TRP BFR medium access control control element (MAC-CE) or a truncated multi-TRP BFR MAC-CE.

Aspect 13: The method of any of Aspects 1 through 12, wherein the serving cell is a secondary cell or a special cell.

Aspect 14: The method of any of Aspects 1 through 13, wherein the SR is associated with an SR resource, wherein the SR resource is configured via an SR resource configuration with PUCCH resources with up to two spatial relations, and wherein the PUCCH resources include two PUCCH resources each configured with one spatial relation or one PUCCH resource configured with two spatial relations.

Aspect 15: A method of wireless communication performed by a base station, comprising: receiving, from a user equipment (UE) via a second transmission-reception point (TRP) based at least in part on a beam failure at a first TRP associated with a serving cell, a scheduling request (SR) for a beam failure recovery (BFR) via a first SR physical uplink control channel (PUCCH) resource; and receiving, from the UE based at least in part on a beam failure at the second TRP associated with the serving cell or another serving cell, the SR via a second SR PUCCH resource with a spatial relation configured for the SR.

Aspect 16: An apparatus for wireless communication at a device, comprising a processor; memory coupled with the processor; and instructions stored in the memory and executable by the processor to cause the apparatus to perform the method of one or more of Aspects 1-14.

Aspect 17: A device for wireless communication, comprising a memory and one or more processors coupled to the memory, the one or more processors configured to perform the method of one or more of Aspects 1-14.

Aspect 18: An apparatus for wireless communication, comprising at least one means for performing the method of one or more of Aspects 1-14.

Aspect 19: A non-transitory computer-readable medium storing code for wireless communication, the code comprising instructions executable by a processor to perform the method of one or more of Aspects 1-14.

Aspect 20: A non-transitory computer-readable medium storing a set of instructions for wireless communication, the set of instructions comprising one or more instructions that, when executed by one or more processors of a device, cause the device to perform the method of one or more of Aspects 1-14.

Aspect 21: An apparatus for wireless communication at a device, comprising a processor; memory coupled with the processor; and instructions stored in the memory and executable by the processor to cause the apparatus to perform the method of Aspect 15.

Aspect 22: A device for wireless communication, comprising a memory and one or more processors coupled to the memory, the one or more processors configured to perform the method of Aspect 15.

Aspect 23: An apparatus for wireless communication, comprising at least one means for performing the method of Aspect 15.

Aspect 24: A non-transitory computer-readable medium storing code for wireless communication, the code comprising instructions executable by a processor to perform the method of Aspect 15.

Aspect 25: A non-transitory computer-readable medium storing a set of instructions for wireless communication, the set of instructions comprising one or more instructions that, when executed by one or more processors of a device, cause the device to perform the method of Aspect 15.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
detect a beam failure at a first transmission-reception point (TRP) associated with a serving cell:
transmit, to a base station via a second TRP, a scheduling request (SR) for a beam failure recovery (BFR) via a first SR physical uplink control channel (PUCCH) resource:
detect a beam failure at a second TRP associated with the serving cell or another serving cell; and
transmit, to the base station, the SR via a second SR PUCCH resource with a spatial relation configured for the SR.

2. The apparatus of claim 1, wherein:
the first SR PUCCH resource and the second SR PUCCH resource with the spatial relation configured for the SR are different SR PUCCH resources of the SR: or
the first SR PUCCH resource and the second SR PUCCH resource with the spatial relation configured for the SR are same SR PUCCH resources of the SR but with different spatial relations.

3. The apparatus of claim 1, wherein the SR is transmitted via the second SR PUCCH resource with the spatial relation configured for the SR based at least in part on no uplink grant being available for the UE.

4. The apparatus of claim 1, wherein the one or more processors are further configured to:
receive, from the base station, an uplink grant; and
transmit, to the base station via the uplink grant, a multi-TRP BFR medium access control control element (MAC-CE) or a truncated multi-TRP BFR MAC-CE that indicates a failed TRP index and a UE-preferred new beam.

5. The apparatus of claim 1, wherein the one or more processors are further configured to:
receive, from the base station, an SR resource configuration for a serving cell BFR in a multi-TRP operation, wherein the SR resource configuration at least indicates an SR prohibit timer and an SR counter.

6. The apparatus of claim 5, wherein the SR prohibit timer is configured per TRP in one SR resource configuration, wherein the UE is not prohibited from transmitting an SR via another PUCCH resource spatial relation, and wherein the SR prohibit timer maintains an SR transmission prohibition within one TRP.

7. The apparatus of claim 5, wherein the SR prohibit timer is configured per SR resource configuration, wherein the SR prohibit timer is shared across the first TRP and the second TRP, wherein the UE is prohibited from transmitting an SR via another PUCCH resource spatial relation when the SR prohibit timer is running, and wherein the SR prohibit timer is started or restarted based at least in part on an SR being transmitted via any PUCCH resource spatial relation.

8. The apparatus of claim 5, wherein the one or more processors are further configured to:
stop the SR prohibit timer associated with each TRP based at least in part on a transmitted multi-TRP BFR medium access control control element (MAC-CE) or a transmitted truncated multi-TRP BFR MAC-CE indicating a failed TRP index.

9. The apparatus of claim 5, wherein:
the SR counter is configured per TRP in one SR resource configuration, and wherein the UE is associated with separate SR counters for each TRP with different SR PUCCH resource spatial relations: or
the SR counter is configured per SR resource configuration, and wherein the SR counter is incremented based at least in part on an SR being transmitted via any PUCCH resource spatial relation.

10. The apparatus of claim 1, wherein the one or more processors are further configured to:
start a timer after transmitting, for the second TRP, the SR via the first SR PUCCH resource:
determine that the timer has expired after detecting the beam failure at the second TRP associated with the serving cell or another serving cell, wherein the SR is transmitted via the second SR PUCCH resource with the spatial relation configured for the SR based at least in part on the timer having expired; and
restart the timer after transmitting the SR via the second SR PUCCH resource with the spatial relation configured for the SR.

11. The apparatus of claim 1, wherein the one or more processors are further configured to:
start a timer after transmitting, for the second TRP, the SR via the first SR PUCCH resource:
receive, from the base station, an uplink grant prior to an expiry of the timer, and
transmit, to the base station via the uplink grant, a multi-TRP BFR medium access control control element (MAC-CE) or a truncated multi-TRP BFR MAC-CE that indicates a failed TRP index and a UE-preferred new beam.

12. The apparatus of claim 1, wherein the one or more processors are further configured to:
perform a random access channel (RACH) procedure for BFR based at least in part on the beam failure at the first TRP and the beam failure at the second TRP; and
transmit, to the base station via an uplink grant and based at least in part on the RACH procedure, a multi-TRP BFR medium access control control element (MAC-CE) or a truncated multi-TRP BFR MAC-CE.

13. The apparatus of claim 1, wherein the serving cell is a secondary cell or a special cell.

14. The apparatus of claim 1, wherein the SR is associated with an SR resource, wherein the SR resource is configured via an SR resource configuration with PUCCH resources with up to two spatial relations, and wherein the PUCCH resources include two PUCCH resources each configured with one spatial relation or one PUCCH resource configured with two spatial relations.

15. An apparatus for wireless communication at a base station, comprising:
a memory; and
one or more processors, coupled to the memory, configured to:
receive, from a user equipment (UE) via a second transmission-reception point (TRP) based at least in part on a beam failure at a first TRP associated with a serving cell, a scheduling request (SR) for a beam failure recovery (BFR) via a first SR physical uplink control channel (PUCCH) resource; and
receive, from the UE based at least in part on a beam failure at the second TRP associated with the serving cell or another serving cell, the SR via a second SR PUCCH resource with a spatial relation configured for the SR.

16. A method of wireless communication performed by a user equipment (UE), comprising:
detecting a beam failure at a first transmission-reception point (TRP) associated with a serving cell;
transmitting, to a base station via a second TRP, a scheduling request (SR) for a beam failure recovery (BFR) via a first SR physical uplink control channel (PUCCH) resource:
detecting a beam failure at a second TRP associated with the serving cell or another serving cell; and
transmitting, to the base station, the SR via a second SR PUCCH resource with a spatial relation configured for the SR.

17. The method of claim 16, wherein:
the first SR PUCCH resource and the second SR PUCCH resource with the spatial relation configured for the SR are different SR PUCCH resources of the SR: or
the first SR PUCCH resource and the second SR PUCCH resource with the spatial relation configured for the SR are same SR PUCCH resources of the SR but with different spatial relations.

18. The method of claim 16, wherein transmitting the SR via the second SR PUCCH resource with the spatial relation configured for the SR is based at least in part on no uplink grant being available for the UE.

19. The method of claim 16, further comprising:
receiving, from the base station, an uplink grant; and
transmitting, to the base station via the uplink grant, a multi-TRP BFR medium access control control element (MAC-CE) or a truncated multi-TRP BFR MAC-CE that indicates a failed TRP index and a UE-preferred new beam.

20. The method of claim 16, further comprising:
receiving, from the base station, an SR resource configuration for a serving cell BFR in a multi-TRP operation, wherein the SR resource configuration at least indicates an SR prohibit timer and an SR counter.

21. The method of claim 20, wherein the SR prohibit timer is configured per TRP in one SR resource configuration, wherein the UE is not prohibited from transmitting an SR via another PUCCH resource spatial relation, and wherein the SR prohibit timer maintains an SR transmission prohibition within one TRP.

22. The method of claim 20, wherein the SR prohibit timer is configured per SR resource configuration, wherein the SR prohibit timer is shared across the first TRP and the second TRP, wherein the UE is prohibited from transmitting an SR via another PUCCH resource spatial relation when the SR prohibit timer is running, and wherein the SR prohibit timer is started or restarted based at least in part on an SR being transmitted via any PUCCH resource spatial relation.

23. The method of claim 20, further comprising:
stopping the SR prohibit timer associated with each TRP based at least in part on a transmitted multi-TRP BFR medium access control control element (MAC-CE) or a transmitted truncated multi-TRP BFR MAC-CE indicating a failed TRP index.

24. The method of claim 20, wherein:
the SR counter is configured per TRP in one SR resource configuration, and wherein the UE is associated with separate SR counters for each TRP with different SR PUCCH resource spatial relations: or
the SR counter is configured per SR resource configuration, and wherein the SR counter is incremented based at least in part on an SR being transmitted via any PUCCH resource spatial relation.

25. The method of claim 16, further comprising:
starting a timer after transmitting, for the second TRP, the SR via the first SR PUCCH resource:
determining that the timer has expired after detecting the beam failure at the second TRP associated with the serving cell or another serving cell, wherein the SR is transmitted via the second SR PUCCH resource with the spatial relation configured for the SR based at least in part on the timer having expired; and
restarting the timer after transmitting the SR via the second SR PUCCH resource with the spatial relation configured for the SR.

26. The method of claim 16, further comprising:
starting a timer after transmitting, for the second TRP, the SR via the first SR PUCCH resource:
receiving, from the base station, an uplink grant prior to an expiry of the timer; and
transmitting, to the base station via the uplink grant, a multi-TRP BFR medium access control control element (MAC-CE) or a truncated multi-TRP BFR MAC-CE that indicates a failed TRP index and a UE-preferred new beam.

27. The method of claim 16, further comprising:
performing a random access channel (RACH) procedure for BFR based at least in part on the beam failure at the first TRP and the beam failure at the second TRP; and
transmitting, to the base station via an uplink grant and based at least in part on the RACH procedure, a multi-TRP BFR medium access control control element (MAC-CE) or a truncated multi-TRP BFR MAC-CE.

28. The method of claim 16, wherein the serving cell is a secondary cell or a special cell.

29. The method of claim 16, wherein the SR is associated with an SR resource, wherein the SR resource is configured via an SR resource configuration with PUCCH resources with up to two spatial relations, and wherein the PUCCH resources include two PUCCH resources each configured with one spatial relation or one PUCCH resource configured with two spatial relations.

30. A method of wireless communication performed by a base station, comprising:
receiving, from a user equipment (UE) via a second transmission-reception point (TRP) based at least in part on a beam failure at a first TRP associated with a serving cell, a scheduling request (SR) for a beam failure recovery (BFR) via a first SR physical uplink control channel (PUCCH) resource; and
receiving, from the UE based at least in part on a beam failure at the second TRP associated with the serving cell or another serving cell, the SR via a second SR PUCCH resource with a spatial relation configured for the SR.
